(19) United States
(12) Patent Application Publication
(10) Pub. No.: US 2016/0259716 A1
(43) Pub. Date: Sep. 8, 2016

(54) REBUILDING AN EXECUTION FLOW FROM AN EXECUTION GRID

(71) Applicant: CA, Inc., New York, NY (US)

(72) Inventor: Kenneth James Grant, Marblehead, MA (US)

(21) Appl. No.: 14/635,289

(22) Filed: Mar. 2, 2015

(51) Int. Cl. G06F 11/36

(52) U.S. Cl. CPC G06F 11/3688; G06F 11/3684

(57) ABSTRACT

A method for creating an execution flow from a sequential list of test cases comprises receiving by an application lifecycle management tool used for computer software testing, the list and removing all dependency associations associated with the test cases. Independently of a graphical user interface, a first test case is designated as a source test case, a sequentially next test case is designated as a subordinate test case, and a dependency association is created between the source test case and the subordinate test case. If any test case is not associated with a dependency association, then the subordinate test case is designated as the source test case, a sequentially next test case from the list is designated as the subordinate test case, and a dependency association is crested between them until every test case in the list is associated with a dependency association.

### BACKGROUND

Various aspects of the present invention relate generally to the technological field of software testing and specifically to building an execution flow in an application lifecycle management program within the technological field of software testing.

An application lifecycle management (ALM) tool manages an application through several stages of the application's lifecycle (e.g., governance, development, and maintenance). In regard to software testing, one aspect of an ALM tool allows a user to simulate the application code using test cases (i.e., inputs to a simulation of the software program) arranged in a test set. The test set may also include dependency relationships between the test cases, wherein one test case must be completed before another test case.

One such application lifecycle management tool is from Hewlett-Packard (HP). As with other ALM tools, the HP ALM tool allows a user to set up test cases in a test set for software testing. The user may list all of the test cases within the test set through a graphical user interface (GUI) panel called an execution grid. As the list is being built, the HP ALM tool automatically generates an initial execution flow where all of the test cases in the list are independent from each other (i.e., no test case must be complete before any other test case may be started). However, the user may manipulate the execution flow of the test set through the GUI in another panel (e.g., an execution flow panel). For example, the user may click on the starting point of an arrow and drag the starting point to a test case. Thus, that test case must be completed before the test case at the ending point of the arrow may be started. Further, the user may click and drag icons of the test cases to order the test cases in the GUI as desired. When a test case is independent of all other test cases, an arrow extends from an icon of the test set to the icon of the independent test case. Thus, every test case has at least one arrow feeding it.

After the execution flow of the test set is modified by the user, the user may add more test cases in the execution grid panel. If so, then the HP ALM tool places the newly added test cases in the execution flow with no dependency on any other test case (i.e., the arrow for the newly added test case starts from the icon of the test set in the execution flow). The user may then use the execution flow panel of the GUI to manipulate the dependency of the newly added test case and the location of the icon for the newly added test case within the flow.

### BRIEF SUMMARY

According to aspects of the present disclosure, a method for creating an execution flow from a sequential list of test cases comprises receiving by an application lifecycle management tool used for computer software testing, the list and removing all dependency associations associated with the test cases. Independently of a graphical user interface, a first test case from the list is designated as a source test case and a sequentially next test case from the list is designated as a subordinate test case. A dependency association is created between the source test case and the subordinate test case such that the subordinate test case depends from the source test case. If any test case is not associated with a dependency association, then the subordinate test case is designated as the source test case, a sequentially next test case from the list is designated as the subordinate test case, and a dependency association is crested between them until every test case in the list is associated with a dependency association.

According to other aspects of the present disclosure, a method for creating an execution flow from a sequential list of test cases comprises receiving by an application lifecycle management tool used for computer software testing, the list and removing all dependency associations associated with the test cases. Independently of a graphical user interface, a last test case from the list is designated as a subordinate test case and a sequentially previous test case from the list is designated as a source test case. A dependency association is created between the source test case and the subordinate test case such that the subordinate test case depends from the source test case. If any test case is not associated with a dependency association, then the source test case is designated as the subordinate test case, a sequentially previous test case from the list is designated as the source test case, and a dependency association is crested between them until every test case in the list is associated with a dependency association.

### BRIEF DESCRIPTION OF THE SEVERAL VIEWS OF THE DRAWINGS

FIG. 1 is a flow chart illustrating a method for automatically creating an execution flow from an execution grid, according to aspects of the present disclosure;

FIG. 2 is a flow chart illustrating an alternate method for automatically creating an execution flow from an execution grid, according to aspects of the present disclosure;

FIG. 3 is a representation of an execution flow panel in a graphical user interface of an application lifecycle management tool before the method of FIG. 1 or FIG. 2 is run, according to aspects of the present disclosure;

FIG. 4 is a representation of an execution flow panel in a graphical user interface of an application lifecycle management tool after the method of FIG. 1 or FIG. 2 is run, according to aspects of the present disclosure; and

FIG. 5 is a block diagram of a computer system having a computer readable storage medium for implementing functions according to various aspects of the present invention as described in greater detail herein.

### DETAILED DESCRIPTION

According to various aspects of the present disclosure, a user may generate an execution flow directly from an execution grid of a test set, ignoring any previously imposed dependencies placed on test cases within the test set by an application lifecycle manager (ALM) tool. The resulting execution flow is based on the order that the test cases are listed in the execution flow, such that each test case listed before an instant test case must be completed before the instant test case is started. In other words, the resulting execution flow is a serialization of the execution grid in the order that the test cases appear in the execution grid.

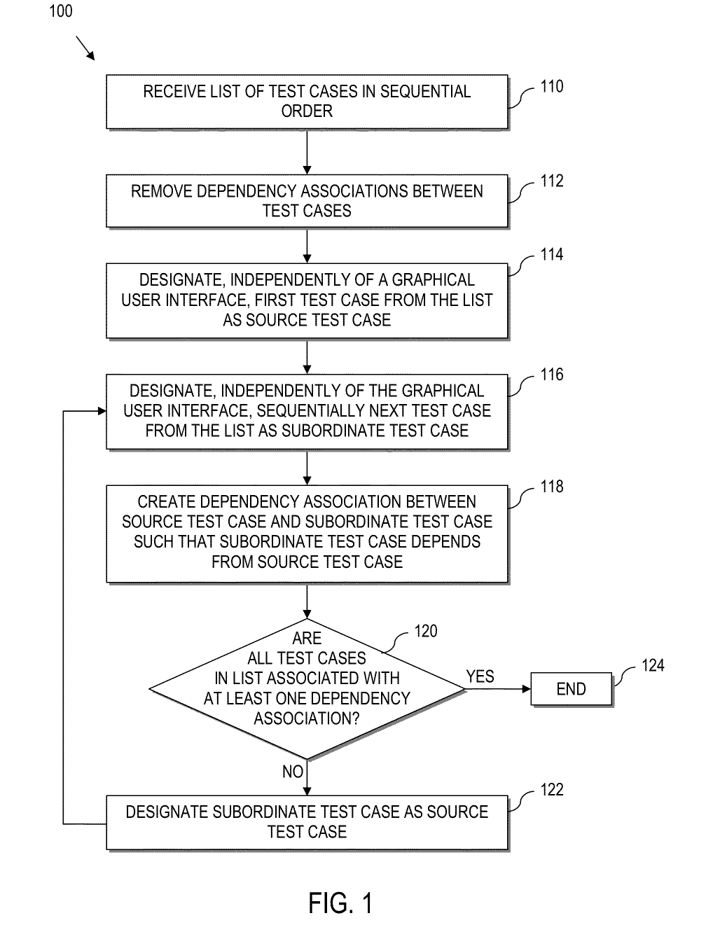

Referring now to the drawings, FIG. 1 is a flowchart illustrating a method 100 of creating an execution flow from a test set of test cases arranged in a list (e.g., an execution grid), which is an advancement in the field of software testing technology. The method 100 may be implemented as a machine-executable method executed on a computer system for creating an execution flow from a test set of test cases, as described more fully herein. In this regard, the method 100 may be implemented on a computer-readable storage device (e.g., computer-readable hardware) that stores machine-executable program code, where the program code instructs a processor to implement the described method. The method 100 may also be executed by a processor coupled to memory, where the processor is programmed by program code stored in the memory, to perform the described method.

At 110, a list of test cases is received in a sequential order. In many cases, the list of test cases may be an execution grid populated and arranged by a user. For example, the user may use a graphical user interface (GUI) of an ALM tool (e.g., in an Execution Grid panel of the ALM tool) to create a test set, which in turn becomes the list of test cases. In such a case, the order that the test cases are listed in the execution grid may be the sequential order of the list of test cases received. It should be understood that when the list of test cases are received that it is the names of the test cases in the list that are received, not the entire test cases themselves.

Further, the list may be received all at one time, or list may be received in parts. For example, the user may add several test cases to a previously created test set and arrange the modified test set in a list with a sequential order to define the list of test cases that are received at 110. As another example, whenever a new test case is added to a list, that information of the newly added test case is considered part of the list of test cases received at 110. As another example, whenever a user changes the order of the list, the new sequential order is considered as the list of test cases received at 110. Also, combinations of the examples may be used (e.g., receiving partial lists of more than one test case, receiving several new test cases to an existing list, receiving a change in an order for those new test cases, etc.).

In some embodiments of the method 100, a start command may be received from a graphical user interface of the ALM tool. For example, when a user clicks a button on the graphical user interface specifically designed to issue a start command, the start command may be received. In other embodiments, the start command may just be the reception of the list, without requiring a separate issuance of a start command. For example, when the user updates the list, a start command may be received. As another example, an application programming interface (API) of an ALM tool may be used to receive the list.

At 112, all dependency associations that are associated with the test cases of the list received at 110 are removed. Dependency associations define an execution order of the test cases. For example, if test_case_A depends from test_case_B, then test_case_B must be completed before test_case_A may start (i.e., test_case_B is a “source” for test_case_A, and test_case_A is “subordinate” to test_case_B). As mentioned above, in the HP ALM tool, dependency associations are indicated in the GUI as an arrow. If a test case is not dependent on any other test case in the test set to complete before starting, then that dependency association may only depend from the test set. For example, in the HP ALM tool, an arrow from the test set icon to a test case icon indicates that the test case is not dependent on any other test case.

At 114, the first test case in the list is designated as a source test case, which is performed independently of any GUI (including the GUI the user is using—if the user is using a GUI). A source test case is a test case from which another test case depends. In some embodiments the first test case is the test case at the top of the list, and in other cases the first test case is at the bottom of the list or somewhere in between.

At 116, the sequentially next test case in the list is designated as a subordinate test case, which (as with element 114 above) is performed independently of any GUI. In some embodiments, the sequentially next test case is the test case below the source test case on the list, while in other embodiments the sequentially next test case is the test case above the source test case on the list.

At 118, a dependency association is created between the source test case and the subordinate test case such that the subordinate test case depends from the source test case.

At 120, a determination is made as to whether all the test cases are associated with at least one dependency association. If not, then the test case that was designated as the destination test case is designated as the source test case at 122, and the method 100 loops back to 116. However, if all of the test cases have at least one dependency association, then the method 100 ends at 124.

Thus, the order in the execution flow is dictated by the order that the test cases were sequentially ordered in the list.

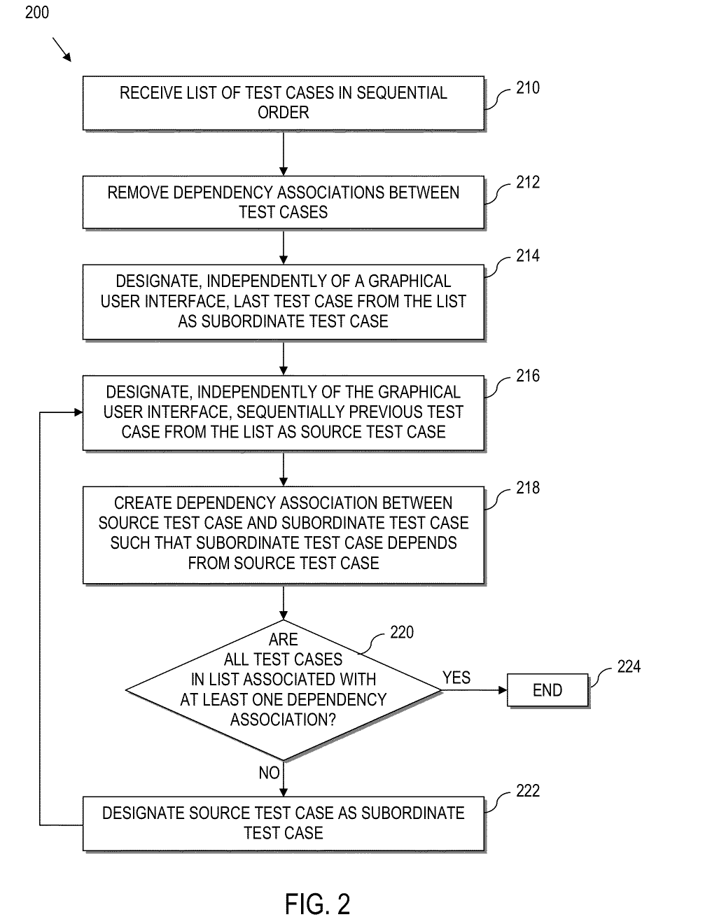

FIG. 2 is a flowchart illustrating an alternate method 200 of creating an execution flow from a test set of test cases arranged in a list (e.g., an execution grid), which is an advancement in the field of software testing technology. The method 200 may be implemented as a machine-executable method executed on a computer system for creating an execution flow from a test set of test cases, as described more fully herein. In this regard, the method 200 may be implemented on a computer-readable storage device (e.g., computer-readable hardware) that stores machine-executable program code, where the program code instructs a processor to implement the described method. The method 200 may also be executed by a processor coupled to memory, where the processor is programmed by program code stored in the memory, to perform the described method.

At 210, a list of test cases is received in a sequential order (similar to 110 of FIG. 1). As with the method 100 of FIG. 1, the list of test cases may be an execution grid populated and arranged by a user. For example, the user may use a graphical user interface (GUI) of an ALM tool (e.g., in an Execution Grid panel of the ALM tool) to create a test set, which in turn becomes the list of test cases. In such a case, the order that the test cases are listed in the execution grid may be the sequential order of the list of test cases received. It should be understood that when the list of test cases are received that it is the names of the test cases in the list that are received, not the entire test cases themselves.

Further as with the method 100 of FIG. 1, the list received at 210 may be received all at one time or may be received in parts. Further, the list may be received all at one time, or list may be received in parts. For example, the user may add several test cases to a previously created test set and arrange the modified test set in a list with a sequential order to define the list of test cases that are received at 110. As another example, whenever a new test case is added to a list, that information of the newly added test case is considered part of the list of test cases received at 110. As another example, whenever a user changes the order of the list, the new sequential order is considered as the list of test cases received at 110. Also, combinations of the examples may be used (e.g., receiving partial lists of more than one test case, receiving several new test cases to an existing list, receiving a change in an order for those new test cases, etc.).

In some embodiments of the method 200, a start command may be received from a graphical user interface of the ALM tool. For example, when a user clicks a button on the graphical user interface specifically designed to issue a start command, the start command may be received. In other embodiments, the start command may just be the reception of the list, without requiring a separate issuance of a start command. For example, when the user updates the list, a start command may be received. As another example, an application programming interface (API) of an ALM tool may be used to receive the list.

At 212, all dependency associations that are associated with the test cases of the list received at 210 are removed (similar to 112 of FIG. 1).

At 214, the last test case in the list is designated as a subordinate test case, which is performed independently of any GUI (including the GUI the user is using—if the user is using a GUI).

At 216, the sequentially previous test case in the list is designated as a source test case, which (as with element 214 above) is performed independently of any GUI. In some embodiments, the sequentially previous test case is the test case above the subordinate test case on the list, while in other embodiments the sequentially previous test case is the test case below the subordinate test case on the list.

At 218, a dependency association is created between the source test case and the subordinate test case such that the subordinate test case depends from the source test case, similar to 118 in method 100 of FIG. 1 above.

At 220, a determination is made as to whether all the test cases are associated with at least one dependency association. If not, then the test case that was designated as the source test case is designated as the subordinate test case at 222, and the method 200 loops back to 216. However, if all of the test cases have at least one dependency association, then the method 200 ends at 224.

Note that the methods 100, 200 will produce the same results: an execution flow with an order dictated by the order that the test cases were sequentially ordered in the list.

### Example 1

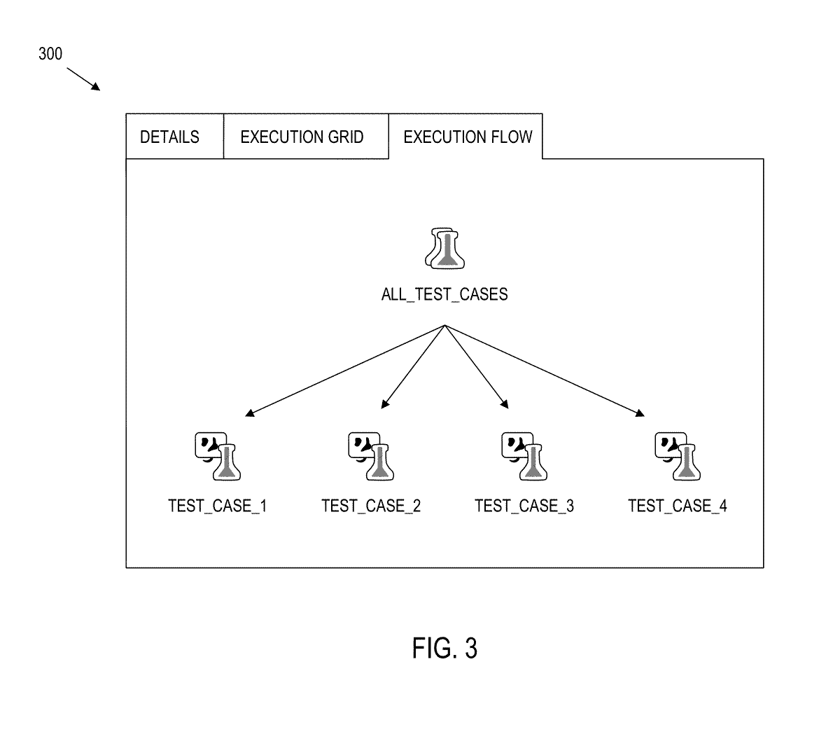

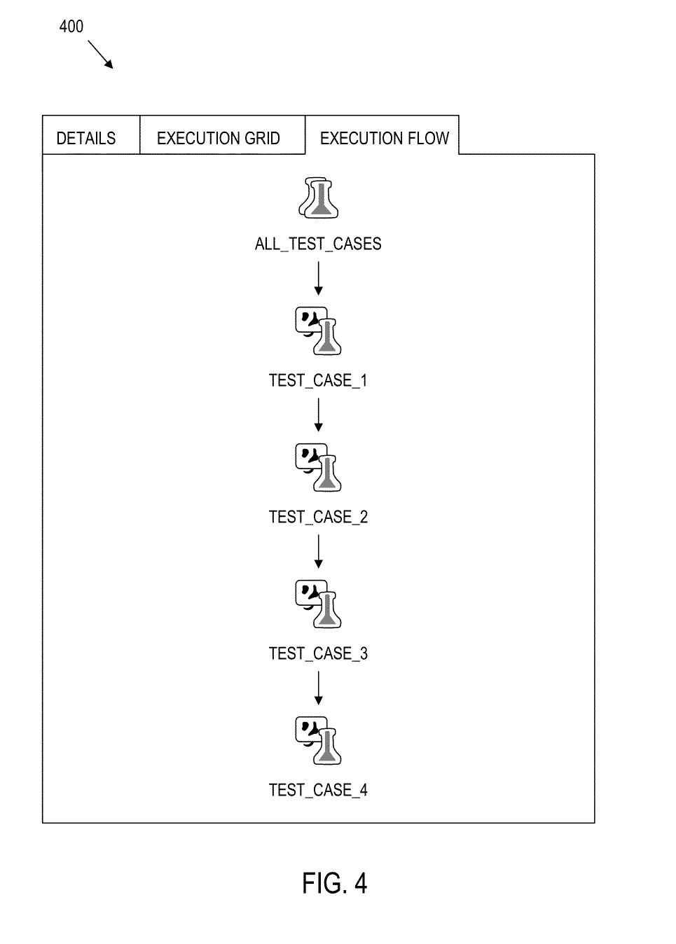

FIGS. 3-4 illustrate a non-limiting example of the execution of the methods disclosed herein (e.g., on a computer used for computer software testing). While the method 100 of FIG. 1 is used in the example, the method 200 of FIG. 2 could easily be used. In the example, a user uses an Execution Grid panel of a GUI in an HP ALM tool to create the following ordered list for a test set named ALL_TEST_CASES:

TEST_CASE_1

TEST_CASE_2

TEST_CASE_3

TEST_CASE_4

FIG. 3 illustrates an automatically generated Execution Flow from the HP ALM tool, where the arrows show dependency associations. As can be seen, all of the test cases only depend from the test set ALL_TEST_CASES. Therefore, according to this automatically generated execution flow, none of the test cases of the test set must be completed before any of the other test cases run. As such, all of the test cases may be executed in parallel if desired.

However, in this example, the user desires that the test cases have dependencies, where each test case above an instant test case in the list must be completed before the instant test case starts. In other words, TEST_CASE_1 must complete before TEST_CASE_2 starts, which must complete before TEST_CASE_3 starts, which must complete before TEST_CASE_4 starts. As such, the user clicks a button in the HP ALM GUI to start the method 100 of FIG. 1.

The list above is received at 110, and the dependency associations are removed at 112. At 114, TEST_CASE_1 (i.e., the first test case in the list) is designated as a source test case, and at 116, TEST_CASE_2 (i.e., the sequentially next test case from the list) is designated as a subordinate test case. At 118, a dependency association is created such that TEST_CASE_1 must complete before TEST_CASE_2 starts.

Not all of the test cases have been associated with at least one association dependency (i.e., TEST_CASE_3 and TEST_CASE_4 have not been associated with at least one association dependency), so the method 100 continues to 122 where TEST_CASE_2 is designated as the source test case, and the method loops back to 116 where TEST_CASE_3 is designated as the subordinate test case. At 118, a dependency association is created such that TEST_CASE_2 must complete before TEST_CASE_3 starts.

Not all of the test cases have been associated with at least one association dependency (i.e., TEST_CASE_4 has not been associated with at least one association dependency), so the method 100 continues to 122 where TEST_CASE_3 is designated as the source test case, and the method loops back to 116 where TEST_CASE_4 is designated as the subordinate test case. At 118, a dependency association is created such that TEST_CASE_3 must complete before TEST_CASE_4 starts.

At this point, all of the test cases are associated with at least one dependency association, so the method 100 ends at 124, and an execution flow is created, which looks like FIG. 4.

### Example 2

A second non-limiting example continues from this point in the first non-limiting example. The user adds TEST_CASE_5 to the execution grid so the list is as follows:

TEST_CASE_1

TEST_CASE_2

TEST_CASE_5

TEST_CASE_3

TEST_CASE_4

The HP ALM will create an execution flow by adding TEST_CASE_5 to the execution flow of FIG. 4, with a dependency association from ALL_TEST_CASES indicating that none of the other test cases must complete before TEST_CASE_5 may be started. When the user clicks the button in the GUI to start the method 100, the list is received at 110, and all of the dependency associations are removed (even the ones created in the first example above).

At 114, TEST_CASE_1 (i.e., the first test case in the list) is designated as a source test case, and at 116, TEST_CASE_2 (i.e., the sequentially next test case from the list) is designated as a subordinate test case. At 118, a dependency association is created such that TEST_CASE_1 must complete before TEST_CASE_2 starts.

Not all of the test cases have been associated with at least one association dependency (i.e., TEST_CASE_5, TEST_CASE_3, and TEST_CASE_4 have not been associated with at least one association dependency), so the method 100 continues to 122 where TEST_CASE_2 is designated as the source test case and the method loops back to 116 where TEST_CASE_5 (as the sequentially next test case in the list) is designated as the subordinate test case. At 118, a dependency association is created such that TEST_CASE_2 must complete before TEST_CASE_5 starts.

Not all of the test cases have been associated with at least one association dependency (i.e., TEST_CASE_3 and TEST_CASE_4 have not been associated with at least one association dependency), so the method 100 continues to 122 where TEST_CASE_5 is designated as the source test case and the method loops back to 116 where TEST_CASE_3 (as the sequentially next test case in the list) is designated as the subordinate test case. At 118, a dependency association is created such that TEST_CASE_5 must complete before TEST_CASE_3 starts.

Not all of the test cases have been associated with at least one association dependency (i.e., TEST_CASE_4 has not been associated with at least one association dependency), so the method 100 continues to 122 where TEST_CASE_3 is designated as the source test case and the method loops back to 116 where TEST_CASE_4 is designated as the subordinate test case. At 118, a dependency association is created such that TEST_CASE_3 must complete before TEST_CASE_4 starts.

At this point, all of the test cases are associated with at least one dependency association, so the method 100 ends at 124, and an execution flow is created, which looks like FIG. 4, except TEST_CASE_5 (which must be completed before TEST_CASE_3 starts) is between TEST_CASE_2 and TEST_CASE_3.

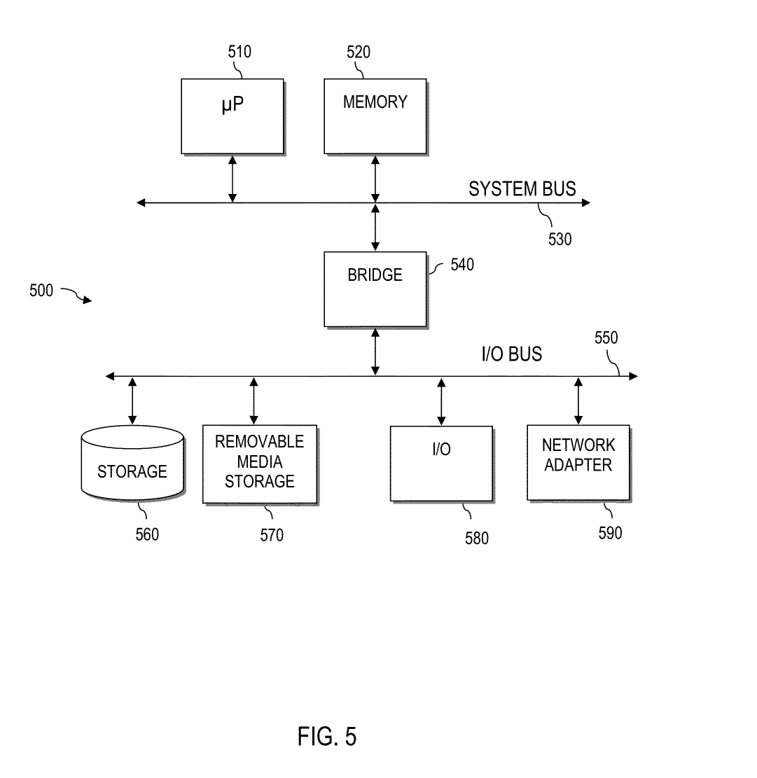

Referring to FIG. 5, a block diagram of an exemplary computer system is illustrated. The computer system 500 includes one or more microprocessors 510 that are connected to memory 520 via a system bus 530. A bridge 540 connects the system bus 530 to an I/O Bus 550 that links peripheral devices to the microprocessor(s) 510. Peripherals may include storage 560, such as a hard drive, removable media storage 570, e.g., tape drive, floppy, flash, CD and/or DVD drive, I/O device(s) 580 such as a keyboard, mouse, etc., and a network adapter 590. In this regard, the microprocessor(s) 510 may thus read computer instructions or otherwise interact with data and other information placed on the system bus 530, e.g., via information stored in the memory 520, stored in the storage 560, stored on the removable media storage 470, entered via the I/O 580, received from the network adapter 590, or combinations thereof, to implement one or more of the aspects, as set out in greater detail herein.

For instance, computer usable program code stored in memory 520 may be executed by the microprocessor 510 to implement any aspect of the present invention, for example, to implement any aspect of any of the methods and/or system components illustrated in FIGS. 1-4.

An object oriented programming system such as Java may run in conjunction with the operating system and provides calls to the operating system from Java programs or applications executing on data processing system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. However, a computer readable storage medium does not include anything described below as a computer readable signal medium.

A computer readable signal medium is a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving by an application lifecycle management tool used for computer software testing, a list of test cases, wherein the test cases in the list are arranged in a sequential order;
removing all dependency associations associated with the test cases, wherein the dependency associations define an execution order of the test cases;
designating, independently of a graphical user interface, a first test case from the list as a source test case;
designating, independently of the graphical user interface, a sequentially next test case from the list as a subordinate test case;
creating a dependency association between the source test case and the subordinate test case such that the subordinate test case depends from the source test case; and
performing until each of the test cases in the list is associated with at least one dependency association:
designating the subordinate test case as the source test case;
designating, independently of the graphical user interface, a sequentially next test case from the list as the subordinate test case; and
creating a dependency association between the source test case and the subordinate test case such that the subordinate test case depends from the source test case.

2. The method of claim 1 further comprising:
receiving a start command initiated in response to a user utilizing the graphical user interface of the application lifecycle management tool before designating, independently of the graphical user interface, the first test case from the list as a source test case.

3. The method of claim 2, wherein receiving a start command comprises receiving the start command in response to the user adding a new test case instance to the list of test cases.

4. The method of claim 1, wherein designating the subordinate test case as the source test case comprises designating the subordinate test case from the list as the source test case directly.

5. The method of claim 1 further comprising sending the dependency associations to the application lifecycle management tool through an application programming interface for the application lifecycle management tool to create an execution flow.

6. The method of claim 5 further comprising sending a refresh command to the associated program through the application programming interface.

7. The method of claim 1 further comprising creating an execution flow from the dependency associations and the list.

8. A computer-readable storage device with an executable program, wherein the program instructs a processor to perform:
receiving by an application lifecycle management tool used for computer software testing, a list of test cases, wherein the test cases in the list are arranged in a sequential order;
removing all dependency associations associated with the test cases, wherein the dependency associations define an execution order of the test cases;
designating, independently of a graphical user interface, a first test case from the list as a source test case;
designating, independently of the graphical user interface, a sequentially next test case from the list as a subordinate test case;
creating a dependency association between the source test case and the subordinate test case such that the subordinate test case depends from the source test case; and
performing until each of the test cases in the list is associated with at least one dependency association:
designating the subordinate test case as the source test case;
designating, independently of the graphical user interface, a sequentially next test case from the list as the subordinate test case; and
creating a dependency association between the source test case and the subordinate test case such that the subordinate test case depends from the source test case.

9. The computer-readable storage device of claim 8, wherein the program further instructs the processor to perform:
receiving a start command initiated in response to a user utilizing the graphical user interface of the application lifecycle management tool before designating, independently of the graphical user interface, the first test case from the list as a source test case.

10. The computer-readable storage device of claim 9, receiving a start command comprises receiving the start command in response to the user adding a new test case instance to the list of test cases.

11. The computer-readable storage device of claim 8, wherein designating the subordinate test case as the source test case comprises designating the subordinate test case from the list as the source test case directly.

12. The computer-readable storage device of claim 8, wherein the program further instructs the processor to perform:
sending the dependency associations to the application lifecycle management tool through an application programming interface for application lifecycle management tool to create an execution flow.

13. The method of claim 12, wherein the program further instructs the processor to perform:
sending a refresh command to the associated program through the application programming interface.

14. The computer-readable storage device of claim 8, wherein the program further instructs the processor to perform:
creating an execution flow from the dependency associations and the list.

15. A method comprising:
receiving by an application lifecycle management tool used for computer software testing, a list of test cases, wherein the test cases in the list are arranged in a sequential order;
removing all dependency associations associated with the test cases, wherein the dependency associations define an execution order of the test cases;
designating, independently of a graphical user interface, a last test case from the list as a subordinate test case;
designating, independently of the graphical user interface, a sequentially previous test case from the list as a source test case;
creating a dependency association between the source test case and the subordinate test case such that the subordinate test case depends from the source test case; and
performing until each of the test cases in the list is associated with at least one dependency association:
designating the source test case as the subordinate test case;
designating, independently of the graphical user interface, a sequentially previous test case from the list as the source test case; and
creating a dependency association between the source test case and the subordinate test case such that the subordinate test case depends from the source test case.

16. The method of claim 15 further comprising:
receiving a start command initiated in response to a user utilizing the graphical user interface of the application lifecycle management tool before designating, independently of the graphical user interface, the first test case from the list as a source test case.

17. The method of claim 16, wherein receiving a start command comprises receiving the start command in response to the user adding a new test case instance to the list of test cases.

18. The method of claim 15, wherein designating the source test case as the subordinate test case comprises designating the source test case from the list as the subordinate test case directly.

19. The method of claim 15 further comprising sending the dependency associations to the application lifecycle management tool through an application programming interface for the application lifecycle management tool to create an execution flow.

20. The method of claim 15 further comprising creating an execution flow from the dependency associations and the list.
